(19) United States
(12) Patent Application Publication
(10) Pub. No.: US 2007/0050791 A1
(43) Pub. Date: Mar. 1, 2007

(54) Structure of slot-in CD player

(76) Inventor: Li-Chung Peng, Hsinchu (TW)

Correspondence Address: LIN & ASSOCIATES INTELLECTUAL PROPERTY, P.O. BOX 2339, SARATOGA, CA, 95070-0339, US

(21) Appl. No.: 11/338,001

(22) Filed: Jan. 23, 2006

(30) Foreign Application Priority Data
Aug. 30, 2005 (TW) 094214952

(51) Int. Cl. G11B 17/04

(52) U.S. Cl. 720/619

(57) ABSTRACT

A structure of a slot-in CD player is provided, including a loading device in a base, a driver, a read-write device and a suppressor. The driver is for driving the loading device to move back and forth within the range of the base. The loading device includes a tray having an opening, and a clipper is installed at the opening. A stopper is installed at the sides of the base. When the disc is inserted from the slot of the base, the clipper at the opening of the tray holds the disc and the driver moves the tray to carry the disc to the read-write device. The stopper stops the disc from further moving while the tray continues to separate from the disc. The suppressor suppresses and holds the disc for rotation. The rotated disc can be read or written by the read-write device.

### FIELD OF THE INVENTION

The present invention generally relates to a structure of a compact disc (CD) player, and more specifically to a structure a slot-in CD player.

### BACKGROUND OF THE INVENTION

The conventional CD players are divided into two types according to the use of loading mechanism. The first type is called tray type, and the second is called slot-in type.

The tray CD player uses a loading tray at the base of the player. The tray can slide out from the base when operated. After the disc is placed on the tray, the tray can slide into the base with the press of a control button or a direct slight nudge at the front edge of the tray. Then, the suppresser device inside the base drags the tray and drives the rotation of the disc. The read-write device reads data from or writes data to the disc. This type of tray CD player has a simple structure, and therefore is less expensive to manufacture. However, because the tray becomes a suspending arm after sliding out from the base, the tray is prone to breakage if accidentally smashed or collided with heavier objects. This becomes a major disadvantage for the tray CD player.

On the other hand, the slot-in CD player uses a design without a tray. The main structure of a slot-in CD player is the complicated mechanical structure inside the base. After the disc is inserted into the slot, the sensor senses the disc and activates the complicated link mechanism to pick up the disc and transfer the disc to a specific position. The suppressor device suppresses the disc and the read-write device reads or writes data. The slot-in CD player has the disadvantage of having a complicated structure and, therefore, is expensive to manufacture.

### SUMMARY OF THE INVENTION

Although the tray CD is simple in structure and inexpensive to manufacture, the disadvantage of breakage in the tray is a major problem. On the other hand, the slot-in CD player does not have the disadvantage of a suspending and breakable tray, the structure is complicated and is expensive to manufacture. Therefore, the primary object of the present invention is to provide a CD play that has the advantages of a slot-in CD player with a simple design similar to that of a tray CD player.

The primary feature of the present invention is to shorten the length of the tray of a conventional tray CD player so that the tray will not be exposed outside of the base when loading a disc. However, to make the unexposed tray support the disc, a clipper is installed on the tray so that the disc, after entering the base, is held by the clipper. By pushing the tray to move slightly, the sensor is triggered to activate the driver to transmit the tray with the disc into the base. A stopper is used to stop the disc, while the tray continues to move inwards inside the base. After the disc is separated from the tray, the suppressor holds and rotates the disc for the read-write device to read data from the disc or write to the disc.

Another feature of the present invention is to include an opening on the tray and the clipper is installed on the top of the opening so as to hold the disc with the bottom of the opening when the disc is inserted into the opening.

The driver of the present invention includes a motor to rotate a gear set. The passive gear of the gear set moves the flexible gear rack attached to the tray so that the tray and move back and forth. In addition, the bulges can be included at the bottoms of the passive gear or tray, and location sensor can be included in the base. When the location sensor senses the bulge for the first time, the motor is activated to rotate the passive gear, which moves the tray through gear rack. When the location sensor senses the bulge for the second time, the motor stops.

To make the clipper separate from the disc for the subsequent suppression after the tray transmits the disc to the suppressor, the present invention includes a first extruding column and a second extruding column on the passive gear, and an extruding rod at the end of gear rack so that when the passive gear is not engaged with the gear rack for rotation, the first extruding column pushes the extruding rod to move the tray into location and the second extruding column pushes the extruding rod to move the tray from the location.

To house the aforementioned structure inside the limited space within the CD player, the present invention uses flexible material for the gear rack and installs a winding guiding trench in the base so that the gear rack bends along the winding guiding trench when the tray moves towards the slot direction.

The clipper of the present invention can be a material with suitable friction coefficient, an elastic body or a steel ball with a spring.

Another embodiment of the driver of the present invention is to use a sheave on the passive gear. The wire whirls around the sheave, with one end attached to the tray. A spring is used to connect the tray and the base. When the motor drives the gear set and the sheave whirls the wire to pull the tray to move towards the slot and pulls the spring. When the motor rotates in the reverse direction, the spring is pulled to move the tray to move inwards inside the base.

By using the aforementioned structure, the back-and-forth movement of the tray is all within the range of the base. Also, because the tray includes a clipper, the disc is held by the clipper after inserted, and is transmitted by the tray to the base for reading or writing. Therefore, the structure operates like a slot-in CD player. But as present invention uses a structure similar to the conventional tray CD player, the structure is simpler than that of the slot-in CD player; thus, it is much economical to manufacture and competitive in price.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a top view of schematic layout of a CD player of the present invention;

FIG. 1A shows a side view of FIG. 1;

FIG. 2 shows a top view of schematic layout of the disc being inserted in the opening of the tray and held by the clipper of the present invention;

FIG. 2A shows a side view of FIG. 2;

FIG. 3 shows a top view of schematic layout of the driver moving the tray and the disc to the read-write device;

FIG. 3A shows a side view of FIG. 3;

FIG. 4 shows a top view of schematic layout of the driver moving the tray inside the base while the disc being retained by the stopper to separate from the tray;

FIG. 4A shows a side view of FIG. 4;

FIG. 5 shows a side view of schematic layout of the suppressor suppressing the disc for the read-write device to read or write data;

FIG. 6 shows a partial schematic view of the second embodiment of the present invention;

FIG. 7 shows a partial schematic view of the third embodiment of the present invention;

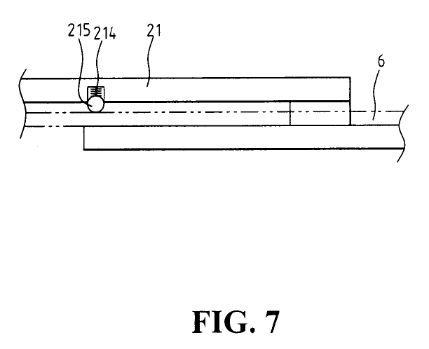

FIG. 8 shows a top view of the schematic layout of a structure of another embodiment of the present invention; and

FIG. 9 shows a schematic view of the operation of FIG. 8.

### DETAILED DESCRIPTION OF THE PREFERRED EMBODIMENTS

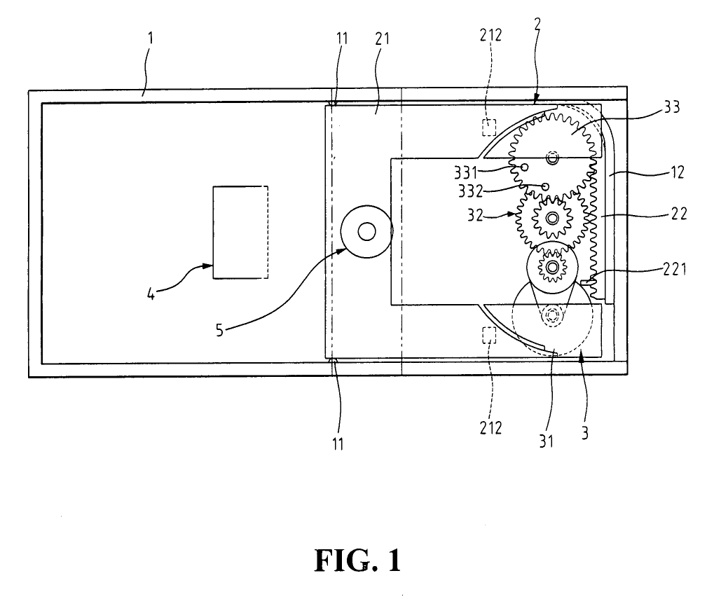

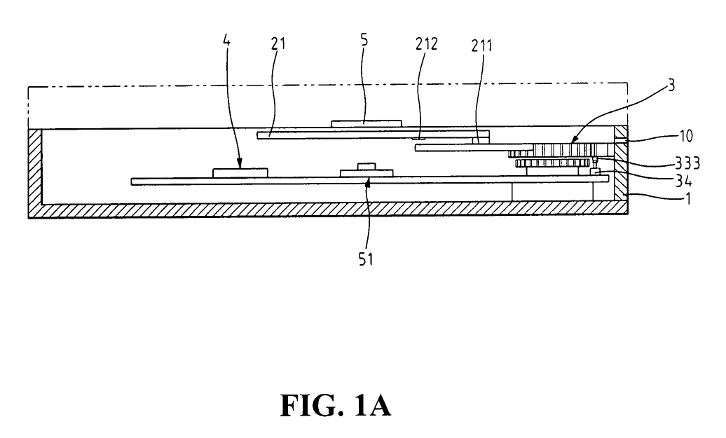

Refer to FIG. 1 and FIG. 1A. The structure of a CD player of the present invention includes a loading device 2 in a base 1, a driver 3, a read-write device 4 and a suppressor 5.

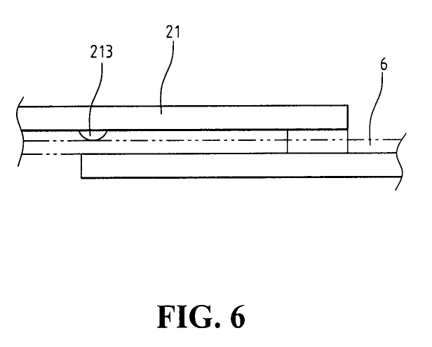

Loading device 2 includes a tray 21. Tray 21 includes an opening 211 at the end facing slot 10. Opening 211 includes a clipper. The stopper 11 is included inside base 1 at the appropriate side locations to stop the disc from moving. There are several embodiments for the clipper. As shown in FIG. 1 and FIG. 1A, the clipper can be a sheet retaining element 212 glued to the top surface of opening 211 of tray 21. Or, the clipper can be an extruding elastic body 213 at the top surface of opening 211, as shown in FIG. 6. The clipper can also be a elastic element 214 and a steel ball 215 placed inside the concave of the top surface of opening 211. By using elastic element 214 to extrude steel ball 215 over the surface of tray 21.

The preferred embodiment of driver 3 includes a motor 31 installed in base 1, a gear set 32, a gear rack 22 attached to the side of tray 21, and a sensor 34 in base 1. Sensor 34 is electrically connected to motor 31. Gear set 32 includes a passive 33 with bulges 333. During the rotation of passive gear 33, when sensor 34 senses bulge 333 for the first time, sensor 34 enables motor 31 to rotate passive gear 33. The rotation of passive gear 33 results in the movement of tray 21 through gear rack 22. When sensor 34 senses bulge 333 for the second time, sensor 34 stops motor 31. To house the aforementioned structure inside the limited space within the CD player, the present invention uses flexible material for gear rack 22 and installs a winding guiding trench 12 in base 1 so that gear rack 22 bends along winding guiding trench 12 when tray 21 moves towards slot 10 when motor 31 operates. Bulges 333 can be installed at two different locations of the bottom of tray 21 (not shown) for sensor 34 to sense for activating or stopping motor 31.

The present invention includes suppressor 5 and read-write device 4 at different locations of case 1. Suppressor 5 includes a rotating plate 51 for supporting the disc. When disc 6 is carried to suppressor 5, suppressor 5 suppresses disc 6 to rotating plate 51 and rotating plate 51 rotates disc 6 for read-write device 4 to read or write data. To make disc 6 separate from tray 21 when disc 6 is carried to suppressor 5, ther top of passive gear 33 include a first extruding column 331 and a second extruding column 332, and an extruding rod 221 at the end of gear rack 22. When passive gear 33 is not engaged with gear rack 22 for rotation, first extruding column will push extruding rod 221 to move tray 21 to the retaining position of suppressor 5, while second extruding column will push extruding rod to move tray 21 away from the retaining location of suppressor 5.

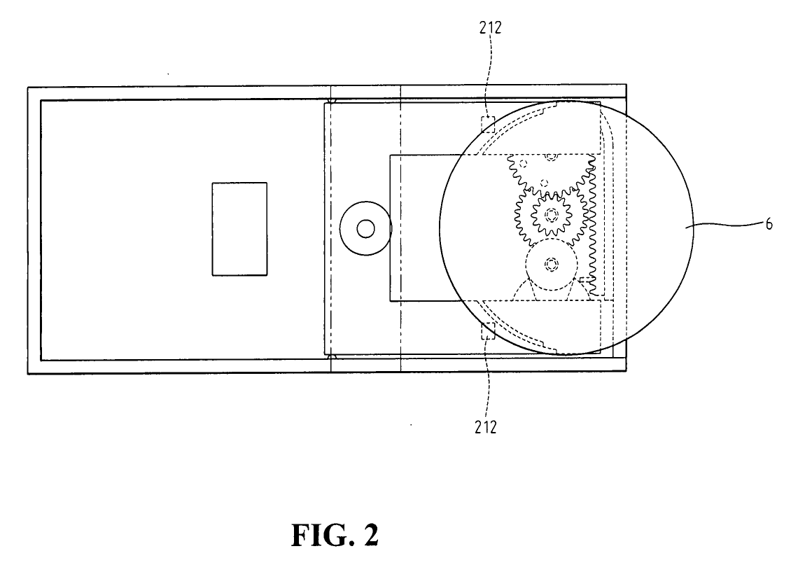

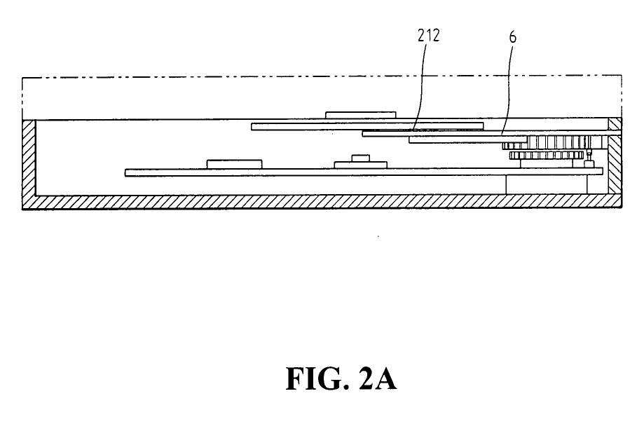

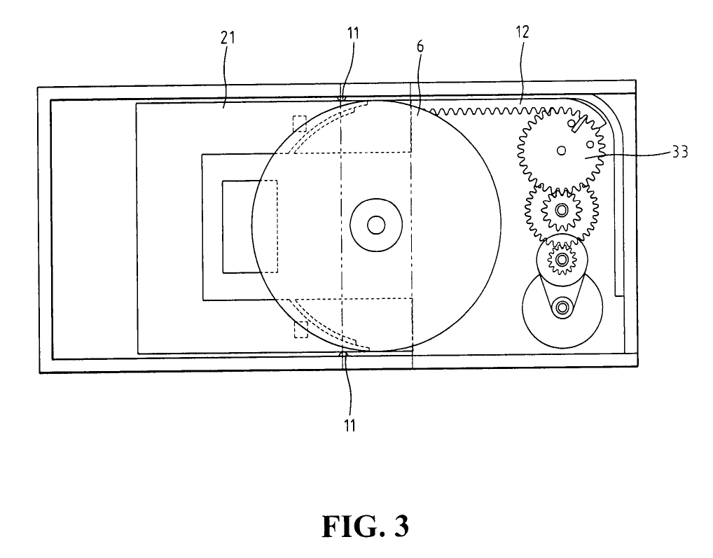

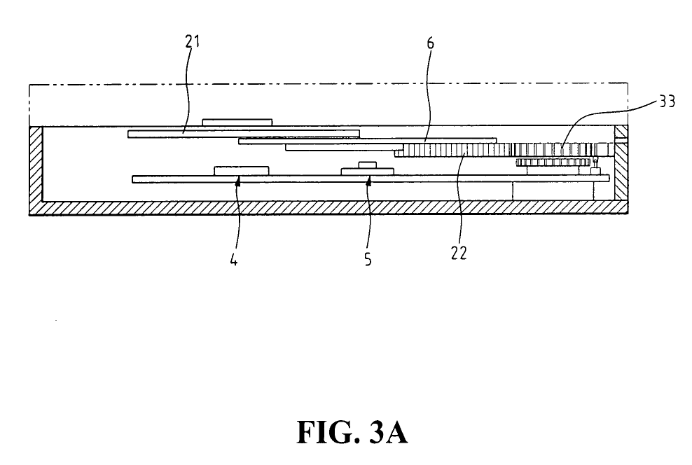

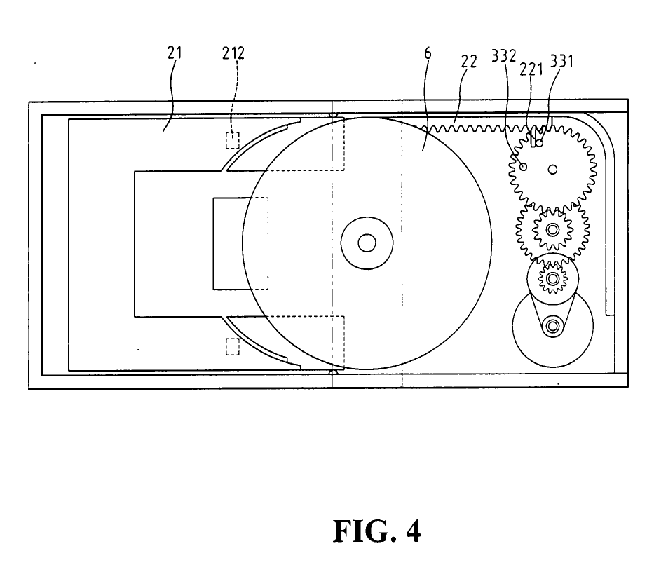

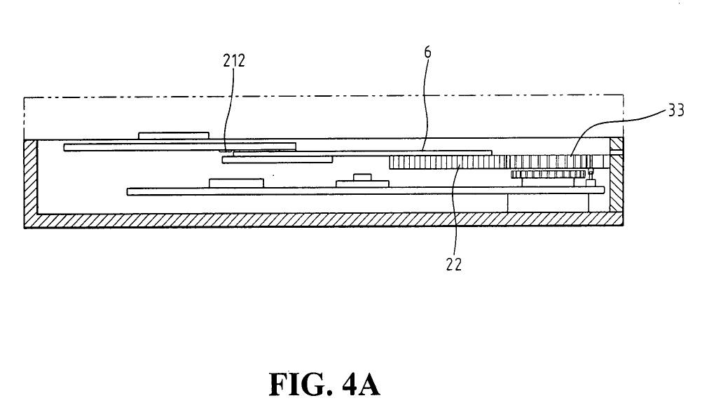

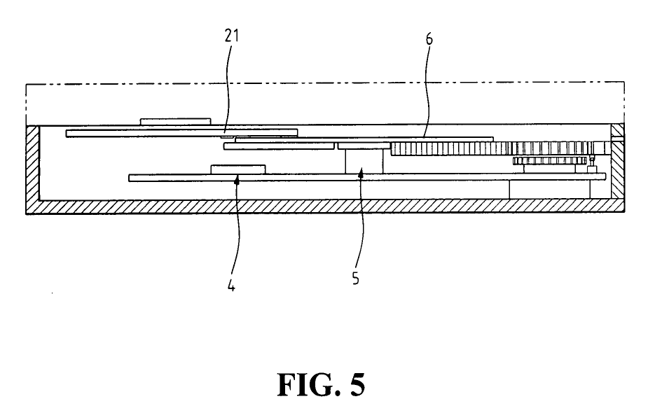

The present invention uses driver 3 to move tray 21 back and forth within the range of base 1 so that tray 21 will not slide out of base 1. The operation of the present invention is to insert disc 6 into slot 10 of base 1. Then, disc 6 enters opening 211 of tray 21 and is held by retaining element 212, elastic body 213 or steel ball 214 with the bottom of opening 211 (as shown in FIG. 2 and FIG. 2A). By pressing a button or pushing disc 6, passive gear 33 or tray 21 is pushed, and sensor 34 senses bulge 333 at the bottom of passive gear 33 or tray 21 to activate motor 31. Motor 31 rotates gear set 32 and passive 33 to move gear rack 22 so that tray 21 moves inwards inside base 1 to suppressor 5 (shown in FIG. 3 and FIG. 3A). At this point, disc 6 is stopped by stopper 11 on both sides at suppressor 5, while passive gear 33 continues rotating and first extruding column 331 pushes extruding rod 221 to make gear rack 22 separate from passive gear 33. Tray 21 continues the movement inwards inside base 1 and is separate from disc 6 (shown in FIG. 4 and FIG. 4A). Then, suppressor 5 holds and rotates disc 6 (shown in FIG. 5), and read-write device 4 reads data from disc 6 or writes data to disc 6. To eject disc 6, the button is pressed to activate motor 31 to rotate in the reverse direction. Passive 33 rotates in reverse and second extruding column 332 pushes extruding rod 221 to make gear rack 22 engaged with passive gear 33. Passive gear 33 drives gear rack 22 so that tray 21 moves to suppressor 5 for disc 6 to enter opening 211 of tray 21, retaining element 212 holds disc 6 and moves disc 6 to slide out of slot 10 of base 1.

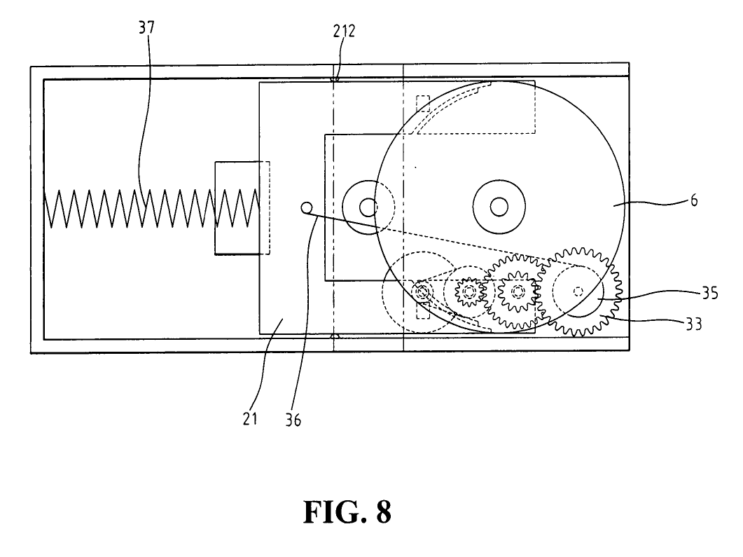

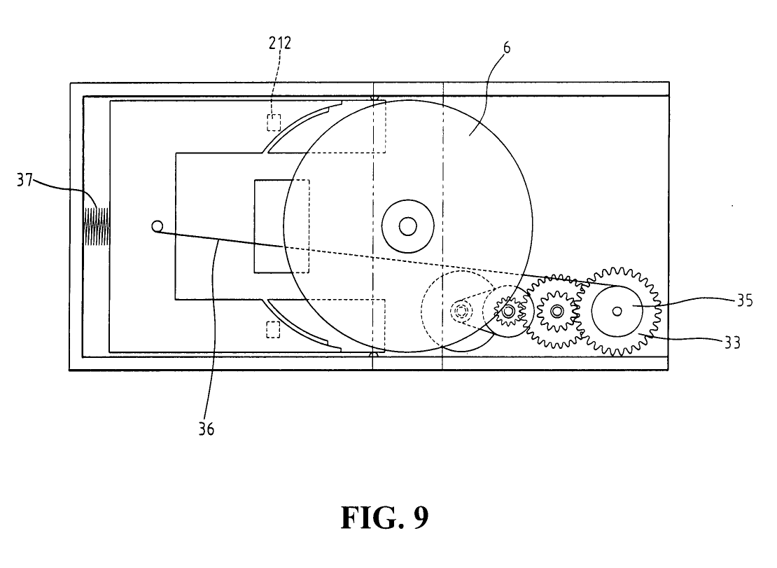

FIG. 8 shows another embodiment of the present invention. The difference is in the driver. In the embodiment of FIG. 8, the motor and gear set can be installed at different location of base 1 so that the gear rack can be omitted. However, a sheave 35 is installed on passive gear 33 of the gear set. Sheave 35 whirls a wire 36, with one end attached to tray 21. The end of tray 21 and base 1 is linked with a spring 37. When motor 31 drives through gear set 32 to rotate sheave 35, wire 36 is pulled and tray 21 moves towards slot 10 (shown in FIG. 9). Spring 37 is pulled to store elasticity. When operated in reverse direction, spring 37 pulls tray 21 back to its original position. The remaining description is omitted as it is the same as the first embodiment.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A structure of a slot-in CD player, comprising a loading device in a base, a driver, a read-write device and a suppressor, said driver for driving said loading device to move back and forth towards a slot, a disc on said loading device being suppressed by said suppressor after said loading device driven to a specific location within said base, said disc rotated and read or written by said read-write device;
wherein said loading device having a tray with an opening facing said slot, a clipper installed at said opening, a stopper installed at the sides of said base, said loading device moving within the range inside of said base.

2. The structure as claimed in claim 1, wherein said driver further comprises a motor, a gear set, a gear rack attached to the side of said tray, and a sensor in said base, said sensor is electrically connected to said motor, said gear set comprises a passive gear with bulges, said passive gear is engaged to said gear rack, when said sensor senses said bulge for the first time, said motor is activated to rotate said passive gear, which moves said tray through said gear rack, and when said sensor senses said bulge for the second time, said motor stops.

3. The structure as claimed in claim 1, wherein said driver further comprises a motor, a gear set, a gear rack attached to the side of said tray, and a sensor in said base, said sensor is electrically connected to said motor, said gear set comprises a passive gear, said passive gear is engaged to said gear rack, said tray has two bulges, when said sensor senses said bulge for the first time, said motor is activated to rotate said passive gear, which moves said tray through said gear rack, and when said sensor senses said bulge for the second time, said motor stops.

4. The structure as claimed in claim 2, wherein said gear rack has an extruding rod at one end, and said passive gear has a first extruding column and a second extruding column, and when said passive gear is not engaged to said gear rack to rotate, said first extruding column pushes said extruding rod to move said tray to a specific location while said second extruding column pushes said extruding rod to move said tray from a specific location.

5. The structure as claimed in claim 3, wherein said gear rack has an extruding rod at one end, and said passive gear has a first extruding column and a second extruding column, and when said passive gear is not engaged to said gear rack to rotate, said first extruding column pushes said extruding rod to move said tray to a specific location while said second extruding column pushes said extruding rod to move said tray from a specific location.

6. The structure as claimed in claim 1, wherein said gear rack is flexible and said base is installed with a winding guiding trench for guiding said flexible gear rack.

7. The structure as claimed in claim 4, wherein said gear rack is flexible and said base is installed with a winding guiding trench for guiding said flexible gear rack.

8. The structure as claimed in claim 1, wherein said clipper is a retaining element at the top surface of said opening of said tray, and said retaining element forms a clipping support for said disc with the bottom of said opening.

9. The structure as claimed in claim 1, wherein said clipper is an elastic body at the top surface of said opening of said tray, and said elastic body forms a clipping support for said disc with the bottom of said opening.

10. The structure as claimed in claim 1, wherein said clipper is an elastic element and a steel ball embedded in a concave at the top surface of said opening of said tray, and said steel ball forms the clipping support for said disc with the bottom of said opening.

11. The structure as claimed in claim 1, wherein said driver further comprises a motor, a gear set, and a sensor in said base, said sensor is electrically connected to said motor, said gear set comprises a passive gear with bulges and a sheave, said sheave is whirled with a wire with one end of said wire attached to said tray, said tray and said base is linked by a spring, when said sensor senses said bulge for the first time, said motor is activated to rotate said passive gear, which moves said tray through said gear rack, and when said sensor senses said bulge for the second time, said motor stops.

12. The structure as claimed in claim 11, wherein said clipper is a retaining element at the top surface of said opening of said tray, and said retaining element forms a clipping support for said disc with the bottom of said opening.

13. The structure as claimed in claim 11, wherein said clipper is an elastic body at the top surface of said opening of said tray, and said elastic body forms a clipping support for said disc with the bottom of said opening.

14. The structure as claimed in claim 11, wherein said clipper is an elastic element and a steel ball embedded in a concave at the top surface of said opening of said tray, and said steel ball forms the clipping support for said disc with the bottom of said opening.
